(19) United States
(12) Patent Application Publication
(10) Pub. No.: US 2015/0375691 A1
(43) Pub. Date: Dec. 31, 2015

(54) DISPLAY, IN PARTICULAR A HEAD-UP DISPLAY, FOR A VEHICLE

(71) Applicant: VALEO ETUDES ELECTRONIQUES, Creteil Cedex (FR)

(72) Inventor: Richard Geloen, Creteil (FR)

(73) Assignee: VALEO ETUDES ELECTRONIQUES, Creteil (FR)

(21) Appl. No.: 14/758,113

(22) PCT Filed: Dec. 16, 2013
(86) PCT No.: PCT/FR2013/000341

§ 371 Date: Aug. 19, 2015

(30) Foreign Application Priority Data
Dec. 28, 2012 (FR) 1262914

(51) Int. Cl. B60R 11/02; G02B 27/01

(52) U.S. Cl. CPC B60R 11/0235; G02B 27/0101; G02B 27/0006

(57) ABSTRACT

The invention relates to a display, in particular a head-up display, for a vehicle, said display comprising; an image-generating device (2); a unit (5) for reflecting rays (4) emitted from the image-generating device (2); and means (30) for heating the lion unit, integrated into the reflection unit (5).

If such information display systems have, for many years, been used in the aeronautical field to allow the pilot to view simultaneously, without having to adjust the vision thereof, the outside environment and information provided by the onboard instruments and being displayed before the pilot on the cockpit, they are now becoming increasingly widespread in the automotive field, and contribute to the vehicle driving assistance.

The display according to the invention will be described hereafter with regard to the use thereof for a car, but it could, of course, be intended for any other transport field in general, once it is necessary to have a display of information in the field of vision of the person in question.

Generally, a head-up display for a vehicle comprises a device for generating images, allowing the formation of the image to be projected.

Moreover, the system is completed by an assembly of mirrors for reflecting the beam emitted from the device, in order to direct the images that it transmits, up to a final optical element allowing the display of a virtual image located in the field of vision of the eyes of the driver, beyond the windscreen.

It is known that the passenger compartment of the vehicle is subjected to notable variations in temperature and humidity (which are intentional or not) which can cause condensation phenomena by forming particularly fogging on the windows of the vehicle and other similar surfaces such as the reflecting mirrors of the display. This happens when the so-called dew-point temperature is reached. Indeed, condensation appears on a material when the temperature of the surrounding air becomes less than the dew-point temperature, which depends on the air relative humidity. Therefore, if the dew point is crossed, there is a risk that the elements of the optical chain of the display (particularly mirrors) are partially fogged up to such an extent that the image transmitted by the beam will be altered, of reduced quality, or illegible, depriving the driver of the information.

The aim of the present invention is to provide a solution to the problem of condensation appearing on the head-up display systems.

To this end, the invention relates to a display, particularly a head-up display, for a vehicle, said display including:
an image generating device,
an assembly for reflecting rays emitted from the image generating device, and
means for heating the reflecting assembly which are incorporated into said reflecting assembly.

In other words, said reflecting assembly is made to be a heating assembly, which allows the formation of condensation on the elements of the optical chain of the display to be prevented. As a result, since the risk of reaching the dew point is eliminated, the image transmitted and obtained on the final screen (image representing the information to be displayed) is sharp, of optimum quality, and without blurred contour or partial or total loss of the image. Therefore, the system of the invention overcomes the aforementioned problem of condensation and does so without an additional component since it is the reflecting means themselves which are provided with the means for solving the problem.

According to various embodiments of the invention which can be taken together or separately:

said heating means are electrical,

said heating means comprise resistors,

said reflecting assembly comprises one or more mirrors and said heating means are incorporated into said mirror or into each of said mirrors,

said resistors are placed at a plurality of areas of said mirror(s),

said display comprises means for detecting fogging on said reflecting assembly,

said display comprises means for driving said heating means,

said driving means are configured to take into account information for detecting fogging on said reflecting assembly,

said image generating device includes a laser source,

said laser source comprises one or more laser diodes.

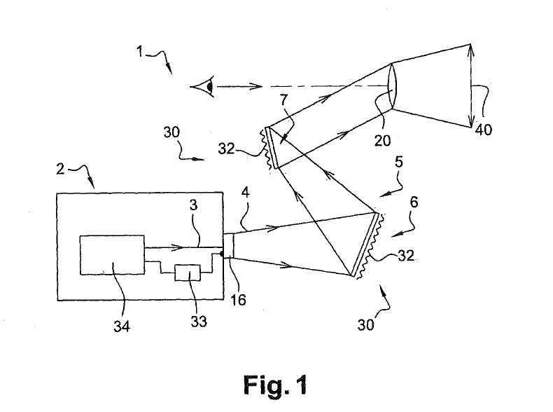

A schematic embodiment of the display in accordance with the invention will be described hereafter with reference to the single appended FIG. 1.

As illustrated in the single figure, the invention relates to a display 1, particularly a head-up display, for a vehicle. It allows the display of virtual images 40.

In a preferential, but not exclusive, use of the invention, said display 1 is intended to be mounted on board a motor vehicle in order to display in the driver field of vision FV, substantially in the line of vision L of the eyes thereof, specific information such as the speed of the vehicle, pieces of information of the navigation system, failures, detections, etc., while preventing the driver from looking away from the road in order to look at the dashboard thereof or the screen of the navigation system.

The display 1 commonly comprises an image generating device 2, outputting rays 4 intended to project the images representing the information to be transmitted. Said device comprises, for example, a scanning projector 34 provided with one or more light sources each emitting a laser beam. These are, for example, laser sources, typically laser diodes, each laser source emitting a monochromatic beam, i.e. consisting of a single color.

Said device can typically comprise three sources, said device being configured to form a light beam via pooling, by combining, the beams individually emitted by each of said sources. More precisely, these can be sources emitting a beam of a color that is different from one source to another. The colors are, for example, red, green or blue (RGB).

The optical power of each of the sources is driven independently using the supply current of the laser source(s). At a given optical power, the color of the light beam is determined by the manner in which a power ratio is established between the various laser diodes. For example, to obtain a white light, the optical powers, proportionally, must be established according to the following distribution: 60 for the green diode, 30 for the blue diode, and 10 for the red diode. The optical power of each of the sources can also be driven to modulate the optical power of the light beam.

The beams emitted by each of the sources are orientated, for example, in parallel with one another and reflected in a same direction in order to form, by combination, a common light beam. Said device comprises, in this respect, optical elements that are semitransparent, over a wavelength range, such as dichroic mirrors or combination plates, intercepting the beams emitted by each of said sources and combining them in the direction of said beam.

More generally, said device is configured to form said light beam from said laser beam(s), regardless of the number of sources in question. In the case of a single source, the light beam is made up of the laser beam emitted by the single source used and the image obtained will then be monochrome, made up of the various levels of optical powers applied to each of the dots making it up, according to a gradation of said color. In the case of a plurality of sources, typically the three sources mentioned above, said common beam which then forms said light beam will allow the establishment of an image according to a spectrum of color, the resolution of which will correspond to the fineness of driving the supply of said sources.

Said device can, furthermore, comprise means for driving the supply of current to said sources. As mentioned above, they can allow the color of the light beam to be chosen.

Said scanning projector 34 further comprises, for example, a scanning generator, the function of which is to horizontally and vertically move the light beam emitted by the light source(s) in order to carry out a scan according to a frequency, particularly equal to 60 Hz, by way of nonlimiting example. The scanning generator particularly comprises a scanning mirror with a microelectromechanical system (hereafter called MEMS mirror) on which the light beam emitted by the light source(s) is reflected as a scanning beam 3. Such a MEMS mirror has, for example, a diameter of 1 mm². The MEMS mirror is suitable for rotating about two axes of rotation in order to carry out a scan, for example at the refresh rate of 60 Hz, of a diffusing screen 16 of said device. The image is then formed on said diffuser 16. Alternatively, the MEMS mirror can be replaced with two plane and movable mirrors, the movements of which are linked. One of these mirrors can be dedicated to scanning in a horizontal axis while the other mirror can be dedicated to scanning in a vertical axis.

The diffuser 16 where the image is formed can be a transparent projection screen with a complex structure for rear projection. It can alternatively be translucent. It is made, for example, from glass, particularly etched glass, or from polycarbonate. For example, the diffusing screen 16 is an exit pupil diffusing screen (“Exit Pupil Expander”). It allows for an enlarged observation cone. It extends in a plane through which the light beam passes, the image resulting from this scanning beam 3 being formed in the plane of a face of the diffusing screen 16.

This diffusing screen receives the scanning beam 3. It is arranged to cause this scanning beam 3 to scatter along an angular sector, for example, equal to 30° with respect to the direction of the scanning beam 3 at the moment where it hits the diffusing screen 16. To this end, according to a nonlimiting example, a face of the diffusing screen is rough, in the sense that it includes bumps which cause the scanning beam to scatter. The rough face corresponds to that through which the beam exits, i.e. the face on which the image is formed.

According to an alternative embodiment, said displaying device can be a screen, particularly a TFT screen.

Downstream of the diffusing screen 16 in the direction of movement of the light beam, said display comprises at least one semi-reflective plate 20 and a reflecting assembly 5 inserted on the path of the image between the diffusing screen 16 and the semi-reflective plate 20. Said reflecting assembly 5 comprises, in this case, mirrors 6, 7 (two mirrors for example) receiving the rays 4 output from the device 2, for the projection of said image 40. In this figure, the path of the image is symbolized by arrows which are reflected on the reflecting device 5 before being displayed through the semi-reflective plate 20. The latter allows an enlargement and/or, by transparency, a display of the image 40 beyond said semi-reflective plate, particularly beyond the windscreen of the equipped vehicle, at a virtual screen, obtained using said semi-reflective plate 20.

This transparent plate has a reflectivity at least equal to 20%, which allows the user to see, through the plate, the route taken by the vehicle, while benefiting from high contrast allowing the displayed image to be seen. Alternatively, the image can be displayed by means of the windscreen of the vehicle provided with said display.

As such, according to the invention, said display further comprises means 30 for heating said reflecting assembly, which are incorporated into said reflecting assembly 5.

Thanks to the invention, the ambient temperature at the surface of the reflecting means is maintained above the dew-point temperature, which allows the formation of condensation on the elements forming the optical chain of the display to be prevented, and a clear and sharp display of the information transmitted before the eyes of the driver to be obtained.

Said heating means 30 are advantageously electrical. They are resistors 32, for example.

Said heating means 30, in particular said resistors 32, can be incorporated into each of said mirrors, particularly at a plurality of areas. In other words, a plurality of resistors is provided per mirror.

With regard to actuating said heating means 30, said display can comprise means for detecting fogging on said reflecting assembly 5, in a direct or indirect manner, for example by measuring a temperature and/or the humidity of the surrounding environment. Said display further comprises means for driving said heating means 30. Said driving means are advantageously configured to take into account information for detecting fogging on said reflecting assembly 5, for example by activating said heating means 30 in the case where fogging is present and/or there is a risk of it being present.

Said image generating device 2 of said display comprises, in this case, control means 33, particularly comprising the means for driving the supply of current to the light sources thereof. Said control means 33 are advantageously configured to actuate, furthermore, said means for driving said heating means 30.

1. A display, particularly a head-up display, for a vehicle, said display comprising:
an image generating device;
an assembly for reflecting rays emitted from the image generating device; and
means for heating said reflecting assembly, which are incorporated into said reflecting assembly.

2. The display as claimed in claim 1, wherein said heating means are electrical.

3. The display as claimed in claim 2, wherein said heating means comprise resistors.

4. The display as claimed in claim 3, wherein said resistors are placed at a plurality of areas.

5. The display as claimed in claim 1, wherein said reflecting assembly comprises one or more mirrors and said heating means are incorporated into said mirror or into each of said mirrors.

6. The display as claimed in claim 1, comprising means for detecting fogging on said reflecting assembly.

7. The display as claimed in claim 1, comprising means for driving said heating means.

8. The display as claimed in claim 7, wherein said driving means are configured to take into account information for detecting fogging on said reflecting assembly.

9. The display as claimed in claim 1, wherein said image generating device includes a laser source.

10. The display as claimed in claim 9, wherein said laser source comprises one or more laser diodes.
